(19) United States
(12) Patent Application Publication
(10) Pub. No.: US 2013/0154926 A1
(43) Pub. Date: Jun. 20, 2013

(54) DEVICE AND METHOD FOR EXECUTING FUNCTION OF PORTABLE TERMINAL

(71) Applicant: Samsung Electronics Co., Ltd., Gyeonggi-do (KR)

(72) Inventors: Kyunghwa KIM, Seoul (KR); Dongjun SHIN, Seoul (KR)

(73) Assignee: Samsung Electronics Co., Ltd., Gyeonggi-do (KR)

(21) Appl. No.: 13/678,929

(22) Filed: Nov. 16, 2012

(30) Foreign Application Priority Data
Dec. 15, 2011 (KR) 10-2011-0135358

(51) Int. Cl. G06F 9/00

(52) U.S. Cl. CPC G06F 9/00
USPC 345/157; 345/156

(57) ABSTRACT

A method for executing a plurality of functions in a portable terminal, includes: confirming a type of a motion experienced by the portable terminal when the motion experienced by the portable terminal is detected by a motion detector; confirming at least two functions preset to correspond to the confirmed type of the motion by referencing a motion mapping table that stores both the at least two functions and the type of motion corresponding to the at least two functions such that the at least two functions are continuously executed in response to a one motion experienced by the portable terminal; and sequentially executing the confirmed at least two functions.

### CLAIM OF PRIORITY

This application claims priority under 35 U.S.C. §119(a) to a Korean Patent Application filed on Dec. 15, 2011 in the Korean Intellectual Property Office and assigned Serial No. 10-2011-0135358, the entire disclosure of which is hereby incorporated by reference.

### BACKGROUND

1. Technical Field

The present invention relates to a device and a method for executing a plurality of functions in a portable terminal, and more particularly, to a device and method for sequentially executing a plurality of functions in response to motions experienced by the portable terminal that correspond to the plurality of functions to be executed.

2. Description of the Related Art

A current portable terminal may execute various types of functions, and has a plurality of input means for executing the various types of functions. The input means may include an external button of a portable terminal, a touch panel of a touch screen, or a voice. An input method of executing a pre-defined command may include a method of using an external button of a portable terminal, a method of using a button on a screen, and a method of using a voice of a user.

The portable terminal may execute a short-cut function by the previously explained input means. The short-cut function refers to a function of executing a specific function using a specific input (button, touch or voice). For example, when a function A is assigned to a specific button, a function A having a different depth (lower depth or higher depth) may be executed by pushing the corresponding or assigned button. However, the short-cut function is limited in that it performs only one function using one input.

### SUMMARY OF THE INVENTION

The present invention has been made in view of the above problems, and provides additional advantages, by providing a device capable of sequentially executing multiple functions of a portable terminal by a single motion. To do this, the portable terminal presets a plurality of functions to correspond to a specific motion, and then the portable terminal sequentially automatically executes predefined commands through motions input by the user.

In accordance with an aspect of the present invention, a device for executing a plurality of functions in a portable terminal, includes: a communication unit performing Internet and near field communication with a base station; a motion detector for detecting a motion experienced by the portable terminal; a memory including a motion mapping table for storing both at least two functions and one type of motion the at least two functions are preset to correspond to. The at least two functions are set to be continuously executed in response to the one motion of the portable terminal preset to correspond to the at least two functions. The portable terminal further includes a controller confirming the at least two functions set to correspond to the detected one motion by referencing the motion mapping table when the one motion is detected by the motion detector; and a display unit displaying the functions executed by the controller.

In accordance with another aspect of the present invention, a method for executing a plurality of functions in a portable terminal, includes: confirming a type of a motion experienced by the portable terminal when the motion experienced by the portable terminal is detected by a motion detector; confirming at least two functions preset to correspond to the confirmed type of the motion by referencing a motion mapping table that stores both the at least two functions and the type of motion the at least two functions are preset to correspond to. The at least two functions are set to be continuously executed in response to a one motion experienced by the portable terminal. The method further includes sequentially executing the confirmed at least two functions.

### BRIEF DESCRIPTION OF THE DRAWINGS

The above features and advantages of the present invention will be more apparent from the following detailed description in conjunction with the accompanying drawings, in which:

FIG. 1 is a block diagram illustrating a configuration of a portable terminal according to an exemplary embodiment of the present invention;

FIG. 2 is a flowchart illustrating a method for sequentially processing a plurality of functions preset to correspond to a particular detected motion in a portable terminal according to an exemplary embodiment of the present invention;

FIGS. 3A-3B are diagrams illustrating examples of updating recent information in a currently operated application (first function) and of moving a cursor to a top end of the currently operated application (second function) by tapping or touching a specific part of a terminal;

FIG. 4 is a diagram illustrating an example of automatically releasing a lock state (first function) and then executing a specific application (second function) by rotating a portable terminal having a touch screen in a locked state. In the present invention, the portable terminal sequentially executes a plurality of functions in response to one motion. For example, the portable terminal detects a shake or rotate motion with tap (one motion), the portable terminal is unlocked and then executes a predefined application(the camera application in FIG. 4) sequentially.

FIG. 5 is a diagram illustrating an example of refreshing a current executed communication mode (first function) and automatically connecting with a recent connected part (second function) by shaking the portable terminal; and

FIG. 6 is a flowchart illustrating an example of executing multiple functions according to user motions detected by the portable terminal according to an exemplary embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. For the purposes of clarity and simplicity, detailed descriptions of well-known functions and structures incorporated herein may be omitted to avoid obscuring the subject matter of the present invention.

The present invention first sets and stores commands that will be used for executing a plurality of functions, the commands being, for example, specific motions detected by the portable terminal. The portable terminal includes sensors used for detecting the specific motions experienced by the portable terminal (e.g., shaking). When motions preset to correspond to the plurality of functions are detected by the sensor of the portable terminal, the present invention sequentially executes the plurality of preset functions. Accordingly, an embodiment of the present invention may execute a plurality of preset functions by one motion (one motion/command to execute multiple functions).

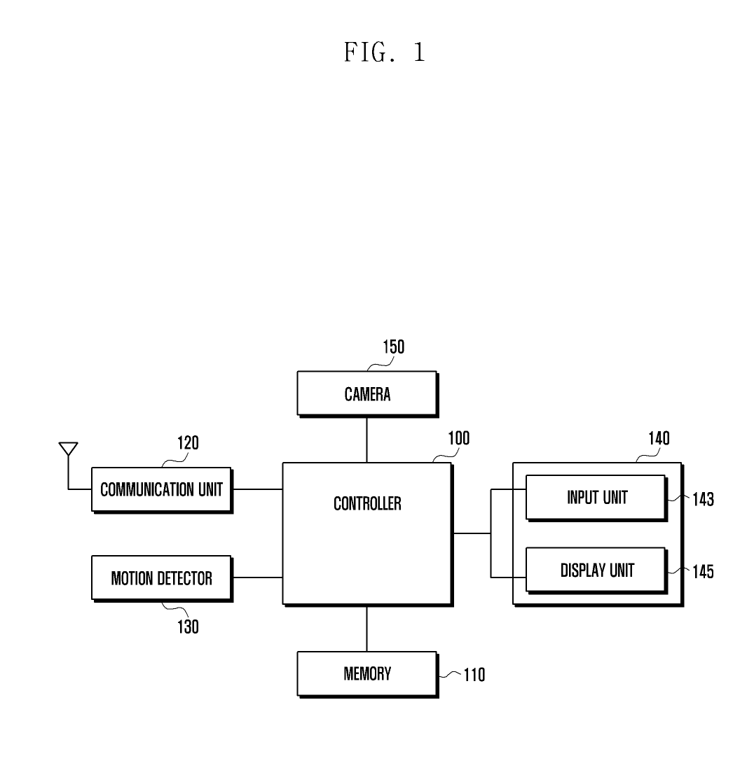

FIG. 1 is a block diagram illustrating a configuration of a portable terminal according to an exemplary embodiment of the present invention.

Referring to FIG. 1, a communication unit 120 executes a wireless communication function with a base station or another device. The communication unit may include a transmitter up-converting a frequency of a transmitted signal and amplifying power of the converted signal, and a receiver low-noise-amplifying a received signal and down-converting the amplified signal. The communication unit 150 may include a modulator and a demodulator. In this example, the modulator modulates a transmitted signal and transfers the modulated signal, and the demodulator demodulates a signal received by the receiver. The modulator/demodulator may include LTE, WCDMA, GSM, Wi-Fi, WIBRO, NFC, and Bluetooth. It is assumed in an embodiment of the present invention that the communication unit 120 includes LTE, Wi-Fi, and Bluetooth communication units.

The controller 100 controls the overall operation of a portable terminal, such that a plurality of functions preset to correspond to a motion experienced by the portable terminal are sequentially executed when detecting a specific motion according to an embodiment of the present invention.

The memory 110 may include a program memory storing an operation program of a terminal and a program according to an embodiment of the present invention, and a data memory storing tables for operating the terminal and data generated during execution of a program. In particular, the memory 110 includes motion mapping tables storing a plurality of functions to be executed when specific motions corresponding to the plurality of functions are detected according to an embodiment of the present invention.

A motion detector 130 detects motions of the portable terminal. The motions may include specific motions detected according to an input for executing a plurality of functions according to the embodiment of the present invention. For example, the motion can be a function detecting tap, rotation, shake, or swing imparted on or experienced by the portable terminal. The motion detector 130 may include an accelerometer and/or a gyro sensor.

The input unit 143 may include a touch panel detecting a touch input of a user. The display unit 145 may include an LCD or OLED panel displaying data or images generated during execution of a program. In this particular embodiment, the input unit 143 and the display unit 145 may be configured as a touch screen 140. A camera 150 is operated under control of the controller 100 and photographs images.

In accordance with an aspect of the present invention, when a user causes the portable terminal to experience a specific motion (e.g., shaking), the portable terminal detects the motion and sequentially processes multiple functions preset to correspond to the detected motions. The portable terminal may accomplish this by including a motion detector 130 for detecting a motion of the portable terminal imparted by a user, and the portable terminal needs to be preset to link or correspond multiple functions with particular motions experienced by the portable terminal imposed by a user (motions of the portable terminal). Once the portable terminal is preset, when a particular motion is detected by the portable terminal the portable terminal will execute the multiple functions that were previously set to correspond to that particular motion. The multiple functions may be previously set during manufacturing of the portable terminal or the user may set a desired function in a set mode.

Accordingly, the memory 110 includes a motion mapping table in which multiple functions are set to be executed according to a motion of the user. The motion (motion of the portable terminal) may include a motion of touching or tapping the portable terminal greater than a predetermined intensity by the user, a motion of rotating the portable terminal greater than a predetermined angle, and a motion of shaking or swinging the portable terminal greater than a predetermined intensity. When the motion occurs, the controller 100 may execute multiple functions stored in the motion mapping table of the memory 110. The controller 100 confirms a current state of the terminal when detecting a motion, and confirms and sequentially executes multiple functions stored in the motion mapping table of the memory 110. The motion mapping table of the memory 110 may include a motion type, a state of the terminal such as an idle state or an active state, and information about at least two functions to be executed. The memory 110 may include a motion type and information about at least two functions to be executed according to the motion.

The foregoing embodiment has illustrated that it is assumed that the functions are set during manufacturing of the portable terminal and are registered in a motion mapping table of the memory 110. However, as mentioned above, the user may set specific motions and multiple functions to be executed in response to the specific motions in a set mode of the portable terminal.

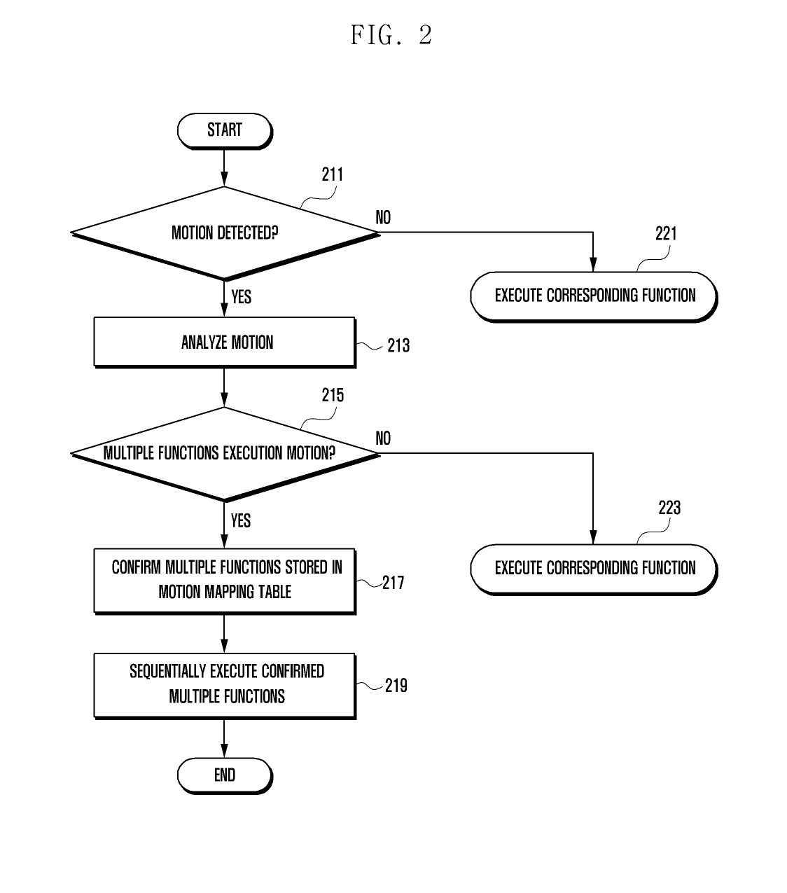

FIG. 2 is a flowchart illustrating a method for sequentially processing a plurality of functions set to correspond to detected motions experienced by a portable terminal according to an exemplary embodiment of the present invention.

Referring to FIG. 2, a motion mapping table of the memory 110 stores multiple functions to be executed according to a particular motion imparted on or experienced by a portable terminal. If the user performs a specific motion in the portable terminal, a motion detector 130 detects the motion and transfers the detected result to the controller 100. The motion detector 130 may include an accelerometer and/or a gyro sensor. The accelerometer is a sensor sensing acceleration and may sense external vibration, an impact amount and direction, and angle change. The gyro sensor is a sensor detecting rotational inertia and may detect a rotating angle. Accordingly, when the accelerometer and the gyro sensor are used, impact, motion, and rotation applied to the portable terminal may be detected. Then, the controller 100 receives information about the motion of the portable terminal (211) from the motion detector 130 and analyzes an output of the motion detector 130 to analyze the type of motion detected (213). After that, the controller 100 determines whether the motion type is a motion preset to correspond to multiple functions by referencing a motion mapping table of the memory 110 (215). When the motion type is a motion preset to correspond to multiple functions, the controller 100 confirms the multiple functions stored in the motion mapping table (217). The controller 100 then sequentially executes the confirmed multiple functions (219) associated with the motion type detected.

As described above, it is appreciated that the present invention detects a motion of a user (motion of portable terminal) to execute preset multiple functions, and may chiefly include a constituent element of recognizing a motion of the user, a constituent element of storing multiple functions corresponding to a particular motion of the user, and a constituent element of processing multiple functions set according to the motion recognition result of the user.

In the portable terminal having the above described constituent elements, when the motion of the user is inputted, the portable terminal determines the input motion. When the input motion is a designated motion, the portable terminal sequentially calls the functions corresponding or linked to the motion, sequentially executes the called functions, and displays a result on the display unit 145. Accordingly, a result of executing at least two functions may be obtained by one motion inputted by the user.

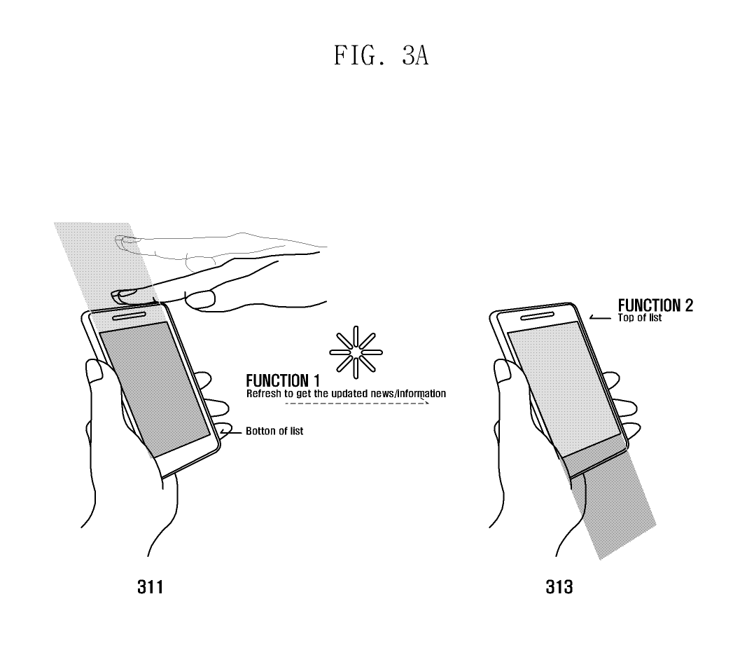

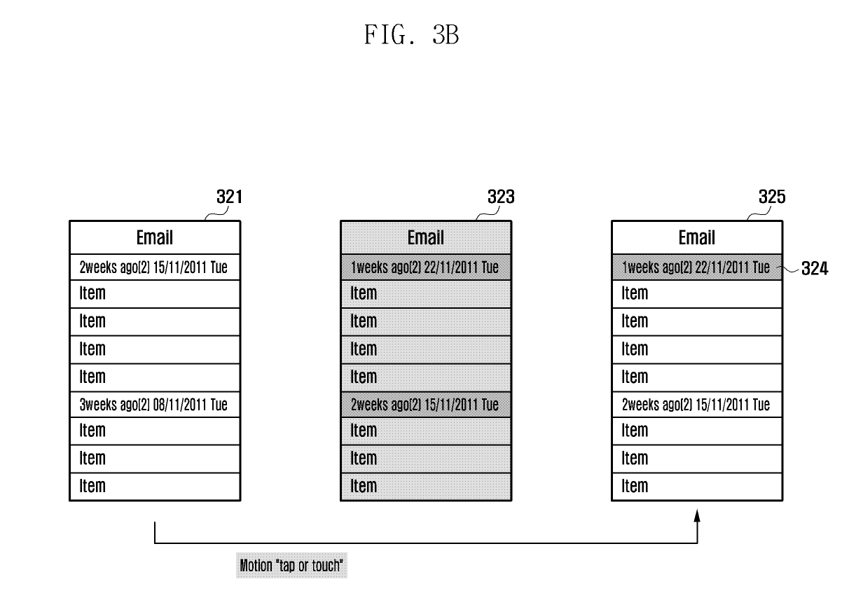

FIGS. 3A-3B are diagrams illustrating examples of updating recent information in a currently operated application (first function) and of moving a cursor to a top end of the currently operated application (second function) by tapping or touching a specific part of a terminal.

Referring to FIGS. 3a and 3b, the user performs a motion of touching or tapping a specific part of the portable terminal greater than a predetermined intensity. FIG. 3B assumes an example of updating an e-mail list. In this example, a motion mapping table is a previously set motion type such as a tap or touch to be associated with a plurality of functions. A first function of the plurality of functions can be updating information of a currently displayed application, and a second function can be setting a cursor to a first item location in the displayed application. Accordingly, if the user touches a specific part of the portable terminal greater than a predetermined intensity 311, the motion detector 130 detects the impact applied to the portable terminal, and the controller 110 updates a list of a currently operated application (application displaying an e-mail list) 321 to display the most recent information 323, and positions a cursor in a first location (top of list) 324 of an updated list 325. Accordingly, after performing a tap motion, a cursor is displayed in a first location 324 of an updated list 325 on a screen 313.

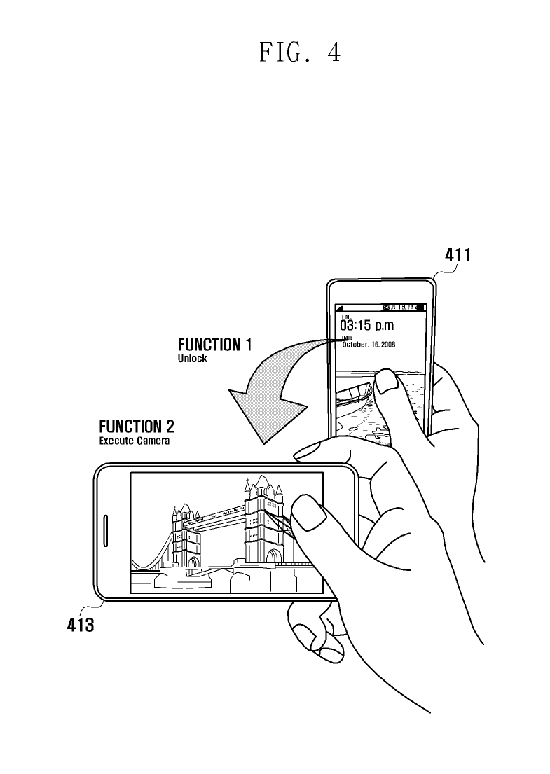

FIG. 4 is a diagram illustrating an example of sequentially releasing a lock state (first function) and executing a specific application (second function) by rotating a portable terminal having a touch screen in a locked state.

Referring to FIG. 4, a user rotates the portable terminal while tapping a screen. When the portable terminal detects a rotate motion with being tapped on display unit, the portable terminal sequentially executes a first function (releases a lock state of portable terminal) and then second function(operates a camera).

In this particular embodiment, a motion mapping table of the memory 110 is set such that when the portable terminal is rotated, the portable terminal is unlocked constituting a first function, and a specific application is automatically executed constituting a second function. Here, the specific application may include operation of a camera 150, operation of a navigation device, operation of an MP3, and operation of a multi-media player. It is assumed in FIG. 4 that the specific application is the operation of the camera 150. Accordingly, when the user rotates the portable terminal greater than a predetermine angle 413 411, the motion detector 130 detects rotation of the portable terminal and informs the controller 100 of the detected motion type. Then, when the rotation of the portable terminal is detected, the controller 100 determines whether the current state of the portable terminal is lock screen mode. When the current state of a terminal is in the lock screen mode, the controller 100 unlocks the lock screen state (first function), and executes an application (second function: allowing for operation of the camera 150) previously set to correspond to the rotation of the portable terminal 413.

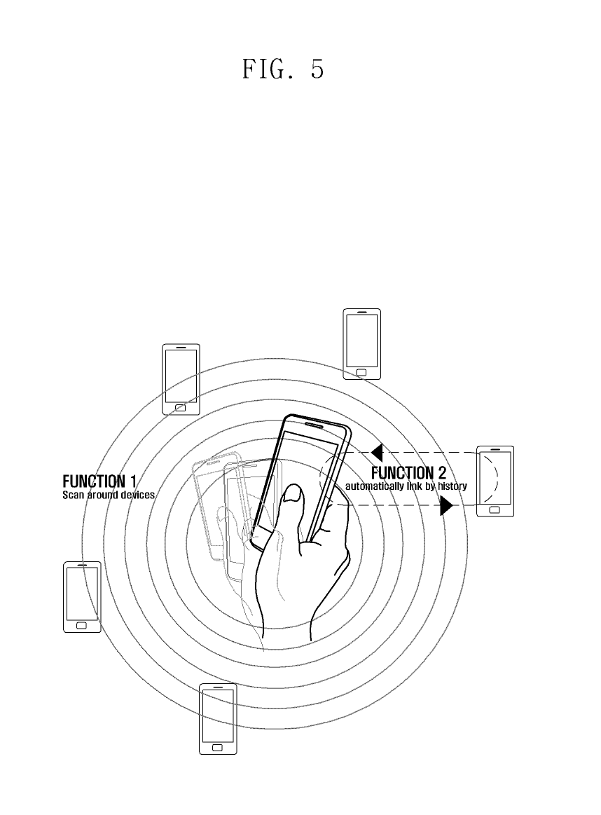

FIG. 5 is a diagram illustrating an example of refreshing a current executed communication mode and automatically connecting with a recent connected part by shaking the portable terminal.

Referring to FIG. 5, a user shakes or swings the portable terminal greater than a predetermined intensity. A motion mapping table of the memory 110 is set such that the motion type triggering execution of at least two functions is a shake or a swing. In response to a shake or a swing of the portable terminal a communication mode refresh (peripheral Internet device in an Internet communication mode, peripheral connectable Wi-Fi connection network in a case of Wi-Fi, peripheral connectable device in a near field communication mode) is searched constituting the first function, and the portable terminal is set to be automatically linked with a recently accessed Internet or subscriber constituting a second function. Here, the communication mode may be Wi-Fi or Bluetooth. Accordingly, when the user shakes or swings the portable terminal, the motion detector 130 detects the shake or swing of the portable terminal and informs the controller 100 of the detection result. Then, when the shake or swing of the portable terminal is detected, the controller 100 confirms a current communication mode and updates a history of a corresponding communication mode (first function), and links the portable terminal with a recently updated communication network or device.

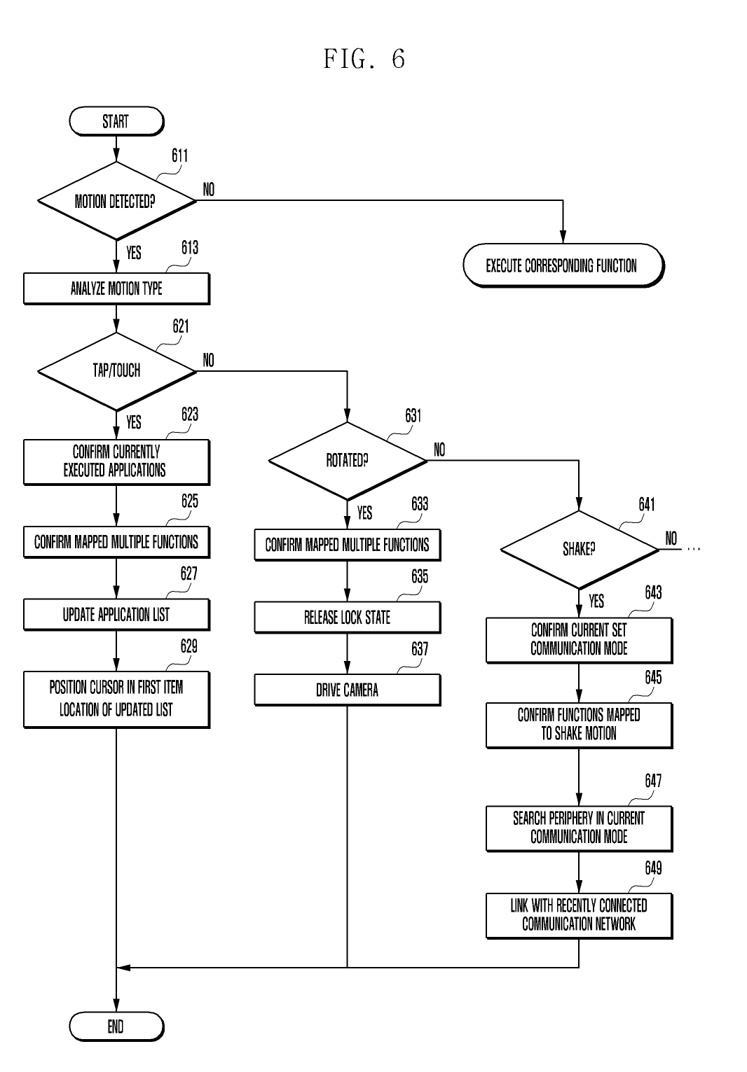

FIG. 6 is a flowchart illustrating an example of executing multiple functions according to a user's motion of the portable terminal according to an exemplary embodiment of the present invention.

As shown, the user performs a preset motion to execute the multiple functions associated with or corresponding to the preset motion. The motion may be a motion of touching, rotating, shaking, or swinging the portable terminal. The foregoing motions may be detected by the motion detector 130. The memory 110 includes a motion mapping table storing multiple functions to be executed in response to one of the foregoing motions. The motion mapping table may store a motion type (e.g., touching), at least two functions to be executed, the order (if not simultaneous) in which the at least two functions are to be executed, and information about applications of a terminal for executing the functions. The motion mapping table of the memory 110 may be set by a manufacturing company during manufacturing of the portable terminal and stored in the memory 110. Alternatively, a user may set at least two functions to correspond to a motion type. The controller 110 may then detect the functions set by the user or manufacturer and then generate and store a motion mapping table including the motion type and the at least two set functions in the memory 110.

When the portable terminal experiences a motion the motion detector 130 detects and outputs the occurred motion to the controller 100. Then, the controller 100 receives information about the motion from the motion detector 130 (611) and analyzes the information to determine the motion type (613). It is assumed that the motion type is a tap as illustrated in FIG. 3A, rotation as illustrated in FIG. 4, or shake or swing as illustrated in FIG. 5.

In this particular embodiment, when the motion type is the tap as illustrated in FIG. 3A, the controller 100 determines it is a tap by an output of the motion detector 130 (621), and confirms currently executed applications (623). The touch motion as illustrated in FIG. 3A may be a command which results in the updating of a list of applications, such as e-mail, during use of the application, thus displaying a refreshed list on the portable terminal and positions a cursor in a first location 324 of the updated list. The list may be a state of displaying items processed in each application such as a call list, an SMS (MMS) list, an e-mail list, an SNS feeds list, a photograph list, or a song list. The controller 100 confirms a currently executed application (623). The controller 100 confirms multiple functions (position a cursor in a first item location of a function updating a list of current applications in a recently processed order and the updated list) corresponding to a current motion type by referencing a motion mapping table of the memory 110 (625). After that, the controller 100 updates a list processed in a currently operated application stored in the memory 110 in a recently processed order 323 (611), and positions a cursor in a first item location 324 of the updated list 325 (629).

Accordingly, as described above, when the user taps an optional location of the portable terminal (FIG. 3A illustrates it in an upper end of the portable terminal), the portable terminal sequentially and automatically performs an update of a list (first function) displayed on the touch screen, due to the first function being preset to correspond to a tap motion of the user, and a cursor location control (second function) also due to the second function being preset to correspond to a tap motion of the user. It is appreciated that an update of a preset list (first function) and the cursor location control (second function) may be simultaneously performed by one tap motion of a user.

When the user rotates the portable terminal while holding the portable terminal having a touch screen 140 being in a lock state, the controller 100 detects a rotating motion of the portable terminal (631). The rotating motion as illustrated in FIG. 4 may be a command of executing a specific application in a lock screen state of the portable terminal. The specific application may be, for example, operation of the camera 150. Then, the controller 100 confirms the functions mapped or corresponding to a rotating motion by referencing a motion mapping table of the memory 110 (633), releases a lock screen state of the touch screen 140 (635), and allows for the operation of a specific application (637). The specific application may be the camera 150. Then, the controller 100 operates the camera 150 (637), and an image photographed by the camera 150 is displayed on the display unit 145. Accordingly, when the user rotates the portable terminal being in the lock screen state, the portable terminal automatically executes a lock state release, which constitutes a first function that corresponds to a rotating motion imparted by the user, and a specific application (making operation of a camera available), which constitutes a second function that also corresponds to a rotating motion imparted by the user. It is appreciated that a preset lock state release and an application may be simultaneously executed by one rotating motion of the user.

When the user shakes or swings the portable terminal, the controller 100 determines that the motion is a rotating motion of the portable terminal based on an output of the motion detector 130 (641). A shake or swing motion of the portable terminal as illustrated in FIG. 5 may be a command which refreshes and scans around network or devices in a current communication mode of the portable terminal and then automatically links with a recently connected communication network or a subscriber. The communication mode may include an Internet communication mode or a near field communication mode. The Internet communication mode may be Wi-Fi and the near field communication mode may be Bluetooth. When the shake or swing is detected, the controller 100 confirms a current set communication mode (643) and confirms functions mapped or corresponding to a shake motion by referencing the motion mapping table (645). Next, the controller 100 searches a periphery in a current communication mode (647) and automatically links with a recently connected communication network or subscriber (automatically link by history) (649). When the communication mode confirmed at step 643 is Wi-Fi communication, the controller 100 refreshes a Wi-Fi communication network and searches peripheral network devices connecting with a Wi-Fi network (647), and connects with a recently linked communication network (649). When the confirmed communication mode is Bluetooth at step 643, the controller 100 scans peripheral connectable devices by a portable terminal (647), and automatically connects with a recent subscriber device (649).

Accordingly, when the portable terminal is shaken as illustrated in FIG. 5, the portable terminal executes a refresh function in a corresponding communication mode serving as a first function set to correspond to a shake motion of the user (refresh, scan around network or devices), and sequentially and automatically performs an automatic motion (automatically link by history) which constitutes the second function. It is appreciated that refresh of a current communication mode and an automatic connection motion may be simultaneously performed by one shake motion of the user.

As described above, according to the present invention, the portable terminal having sensors detecting a motion may sequentially execute a plurality of functions. To do this, a motion of a user is performed for executing a plurality of functions corresponding to the motion. The plurality of functions are previously set and stored and the portable terminal detects the set motion using the sensor, and the portable terminal sequentially executes the plurality of functions set to correspond to the motions. Accordingly, an embodiment of the present invention has an effect capable of executing a plurality of functions set by one motion (one motion to do multiple functions).

A method of executing a function in a portable terminal according to an embodiment of the present invention includes sequentially executing a plurality of functions by a motion of a user, thereby processing the functions using one motion as well as providing a one dimensional short cut rapidly executing multiple functions (one motion to do multiple tasks). Therefore, one advantage of the present invention is that it provides a short-cut to a user destination by performing at least two functions based on one motion of a user.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A device for executing a plurality of functions in a portable terminal, the device comprising:
a motion detector for detecting a motion experienced by the portable terminal;
a memory including a motion mapping table for storing both at least two functions and the type of motion the at least two functions are set to correspond to such that the at least two functions are continuously executed in response to one type of motion experienced by the portable terminal;
a controller confirming the at least two functions set to correspond to the detected one motion by referencing the motion mapping table when the one motion is detected by the motion detector.

2. The device of claim 1, further comprising a display unit displaying the functions executed by the controller.

3. The device of claim 1, further comprising a communication unit performing Internet and near field communication with a base station.

4. The device of claim 1, wherein the motion detector comprises at least one of an accelerometer and a gyro sensor.

5. The device of claim 4, wherein when a tap motion is detected by the motion detector, the controller updates a list of an application currently operating and positions a cursor in a first location of the updated list.

6. The device of claim 5, wherein the list comprises at least one of a call list, an SMS/MMS list, an e-mail list, an SNS feeds list, a photograph list and a song list.

7. The device of claim 3, wherein when a rotating motion is detected by the motion detector, the controller releases a lock screen mode of the portable terminal and automatically executes an application that was preset to correspond to the detection of a rotating motion.

8. The device of claim 7, wherein the application preset to correspond to the detection of a rotating motion is the operation of a camera.

9. The device of claim 3, wherein when a shake motion is detected by the motion detector, the controller searches and refreshes a periphery of a currently executed mode and automatically links with a recently connected communication network or subscriber.

10. The device of claim 9, wherein when the communication mode is Wi-Fi, the controller searches a periphery in a Wi-Fi communication mode and automatically links with a recently linked Wi-Fi network according to the searched result.

11. The device of claim 9, wherein when the communication mode is Bluetooth, the controller searches peripheral devices in a Bluetooth communication mode and automatically links with a recently linked device according to the searched result.

12. A method for executing a plurality of functions in a portable terminal, the method comprising:
confirming a type of a motion of the portable terminal when the motion experienced by the portable terminal is detected by a motion detector;
confirming at least two functions set to correspond to the confirmed type of the motion by referencing a motion mapping table that stores both the at least two functions and the type of motion the at least two functions are set to correspond to, such that the at least two functions are continuously executed in response to one type of motion experienced by the portable terminal; and
sequentially executing the confirmed at least two functions set to correspond to the one motion experienced by the portable terminal.

13. The method of claim 12, wherein the motion detector comprises at least one of an accelerometer and a gyro sensor, and wherein the types of motion comprise tap, rotation, shake, and swing.

14. The method of claim 13, wherein sequentially executing the at least two functions when a tap motion is detected by the motion detector, comprises:
updating a list of an application currently being operated on a display unit of the portable terminal; and
positioning a cursor in a first location of the updated list.

15. The method of claim 14, wherein the list of an application currently being operated comprises at least one of a call list, an SMS/MMS list, an e-mail list, an SNS feeds list, a photograph list and a song list.

16. The method of claim 13, wherein sequentially and continuously executing the at least two functions when a rotating motion is detected by the motion detector comprises:
releasing a lock screen mode of the portable terminal; and
automatically executing an application preset to correspond to the detection of a rotating motion.

17. The method of claim 16, wherein the application preset to correspond to the detection of a rotating motion is the operation of a camera.

18. The method of claim 13, wherein sequentially and continuously executing the at least two functions when a shake motion is detected by the motion detector comprises:
searching and refreshing a periphery of a currently executed mode; and
automatically linking with a recently connected communication network or subscriber.

19. The method of claim 18, wherein sequentially and continuously executing the at least two functions when the communication mode is Wi-Fi comprises:
searching a periphery in a Wi-Fi communication mode; and
automatically linking with a recently linked Wi-Fi network according to the searched result.

20. The method of claim 18, wherein sequentially and continuously executing the at least two functions when the communication mode is Bluetooth comprises:
searching peripheral devices in a Bluetooth communication mode; and
automatically linking with a recently linked device according to the searched result.
